(19) United States
(12) Patent Application Publication
(10) Pub. No.: US 2021/0118067 A1
(43) Pub. Date: Apr. 22, 2021

(54) CONFIGURATION AND PARAMETERIZATION OF ENERGY CONTROL SYSTEM

(71) Applicant: Siemens Aktiengesellschaft, munich (DE)

(72) Inventors: Ulrich Muenz, Plainsboro, NJ (US); Joachim Bamberger, Stockdorf (DE)

(21) Appl. No.: 16/464,370

(22) PCT Filed: Sep. 21, 2017
(86) PCT No.: PCT/US2017/052672

§ 371 Date: May 28, 2019

Related U.S. Application Data
(60) Provisional application No. 62/434,475, filed on Dec. 15, 2016.

(51) Int. Cl. G06Q 50/06; H02J 3/38

(52) U.S. Cl. CPC G06Q 50/06; H02J 2300/10; H02J 3/381

(57) ABSTRACT

Examples of techniques for configuring and parameterizing an energy control system are disclosed. In one example implementation according to aspects of the present disclosure, a computer-implemented method includes receiving, by a processing device, a plurality of digital twins. Each digital twin of the plurality of digital twins is associated with a component of a plurality of components. The method further includes computing, by the processing device, configuration and parameterization information for each of the plurality of components based at least in part on the plurality of digital twins. The method further includes transmitting, by the processing device, the configuration and parameterization information to respective components of the plurality of components to enable the plurality of components to implement the configuration and parameterization information.

### BACKGROUND

The present disclosure generally relates to energy control systems and more particularly to configuration and parameterization of energy control systems.

Power systems provide a network of electronic components to generate, transfer, and supply electric power from a power generator to a power consumer. Power systems can include a generator(s) to generate power, transmission systems to transfer the power across large distances, and distribution systems that distribute the power to power consumers. An electrical grid is an example of a power system. Energy control systems can be implemented to manage and control the various electronic components of power systems.

### SUMMARY

According to examples of the present disclosure, techniques including methods, systems, and/or computer program products for configuring and parameterizing an energy control system are provided. A computer-implemented method for configuring and parameterizing an energy control system includes receiving, by a processing device, a plurality of digital twins. Each digital twin of the plurality of digital twins is associated with a component of a plurality of components. The method further includes computing, by the processing device, configuration and parameterization information for each of the plurality of components based at least in part on the plurality of digital twins. The method further includes transmitting, by the processing device, the configuration and parameterization information to respective components of the plurality of components to enable the plurality of components to implement the configuration and parameterization information.

A system for configuring and parameterizing an energy control system includes a memory having computer readable instructions and a processing device for executing the computer readable instructions for performing a method. The method includes receiving, by a processing device, a plurality of digital twins. Each digital twin of the plurality of digital twins is associated with a component of a plurality of components. The method further includes computing, by the processing device, configuration and parameterization information for each of the plurality of components based at least in part on the plurality of digital twins. The method further includes transmitting, by the processing device, the configuration and parameterization information to respective components of the plurality of components to enable the plurality of components to implement the configuration and parameterization information.

A computer program product for configuring and parameterizing an energy control system includes a computer readable storage medium having program instructions embodied therewith, the program instructions being executable by a virtual reality processing system to cause a processing device to perform a method. The method includes receiving, by a processing device, a plurality of digital twins. Each digital twin of the plurality of digital twins is associated with a component of a plurality of components. The method further includes computing, by the processing device, configuration and parameterization information for each of the plurality of components based at least in part on the plurality of digital twins. The method further includes transmitting, by the processing device, the configuration and parameterization information to respective components of the plurality of components to enable the plurality of components to implement the configuration and parameterization information.

Another method for configuring and parameterizing an energy control system includes receiving, by a processing device, a plurality of digital twins, wherein each digital twin of the plurality of digital twins is associated with a component of a plurality of components. The method further comprises computing, by the processing device, configuration and parameterization information for at least one of a secondary controller and a tertiary controller based at least in part on the plurality of digital twins. The method further comprises transmitting, by the processing device, the configuration and parameterization information to the at least one of the secondary controller and the tertiary controller to enable the at least one of the secondary controller and the tertiary controller to implement the configuration and parameterization information.

Additional features and advantages are realized through the techniques of the present disclosure. Other aspects are described in detail herein and are considered a part of the disclosure. For a better understanding of the present disclosure with the advantages and the features, refer to the following description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages thereof, are apparent from the following detailed description taken in conjunction with the accompanying drawings in which:

FIG. 1A depicts a block diagram of an energy control system, according to aspects of the present disclosure;

FIG. 1B depicts a block diagram of the energy control system of FIG. 1A having an energy control systems configuration and parameterization module, according to aspects of the present disclosure;

FIG. 1C depicts a block diagram of the energy control system of FIG. 1A having an energy control systems configuration and parameterization module, according to aspects of the present disclosure;

FIG. 2 depicts a flow diagram of a method for configuring and parameterizing an energy control system, according to aspects of the present disclosure; and

FIG. 3 depicts a processing system for implementing the techniques described herein according to examples of the present disclosure.

### DETAILED DESCRIPTION

Engineering and commissioning of power systems can be a time consuming, manual task, which includes configuration and parameterization of energy control systems that manage and control the various electronic components of power systems. The present techniques address this problem by providing automatic self-configuration and self-parameterization of energy control systems.

In particular, the present techniques compute configuration and parameterization information for each of a plurality of components in a power system using “digital twins” received from each of the components. A digital twin is a digital replica or representation of physical assets, processes, and systems. For example, a digital twin can include controller structures and tunable parameters for an element of a component of the power system. Digital twins can also include cost functions and constraints for certain elements (e.g., battery capacity), load profiles, and state-of-health of a component.

In this way, the components act as Internet of Things (IoT) objects. The term IoT object refers to any object (e.g., a component, an appliance, a sensor, etc.) that has an addressable interface (e.g., an Internet protocol (IP) address, a Bluetooth identifier (ID), a near-field communication (NFC) ID, etc.) and can transmit information to one or more other objects over a wired or wireless connection. An IoT object can have a passive communication interface, such as a quick response (QR) code, a radio-frequency identification (RFID) tag, an NFC tag, or the like, or an active communication interface, such as a modem, a transceiver, a transmitter-receiver, or the like. An IoT object can have a particular set of attributes (e.g., a device state or status, such as whether the IoT object is on or off, open or closed, idle or active, available for task execution or busy, and so on, a cost function for power generation, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT objects can include, but are not limited to, refrigerators, toasters, ovens, microwaves, freezers, dishwashers, hand tools, clothes washers, clothes dryers, furnaces, heating, ventilation, air conditioning & refrigeration (HVACR) systems, air conditioners, thermostats, burner and boiler controls, power generators, building management controls, televisions, light fixtures, vacuum cleaners, sprinklers, electricity meters, gas meters, etc., so long as the devices are equipped with an addressable communications interface for communicating with the IoT network. IoT objects can also include cell phones, desktop computers, laptop computers, tablet computers, personal digital assistants (PDAs), etc. Accordingly, the IoT network can include a combination of “legacy” Internet-accessible devices (e.g., laptop or desktop computers, cell phones, etc.) in addition to devices that do not typically have Internet-connectivity (e.g., dishwashers, etc.).

The digital twin is transmitted over a communication network to an Energy Control Systems Configuration and Parameterization (ECSCP) module. The energy control system provides control at various levels of the power system, including low-level control, primary control, secondary control, and/or tertiary control. The ECSCP module collects digital twins from components within the power system and combines them in order to configure and parameterize the energy control system in whole or in part (e.g., some components of the energy control can be pre-configured while others are configured by the ECSCP module). For example, the ECSCP module uses a component's cost functions and component-specific constraints to configure and parameterize a model-predictive controller (MPC) of a tertiary controller. The ECSCP module sends the computed configurations and parameters to the individual controllers and components using the communication network. The different controllers apply the received configuration and parameterization information in order to control one or more of the associated components within the power system.

The present techniques provide several benefits. For example, engineering and commissioning costs of power systems and their energy control systems are reduced. When a power outage in the power system occurs (as a result of faults in the power system, weather events, earthquakes, etc.), the present techniques provide for online re-configuration and re-parameterization of energy control systems.

Example embodiments of the disclosure include or yield various technical features, technical effects, and/or improvements to technology. Example embodiments of the disclosure provide an energy control system configured to control a power system and its components by computing configuration and parameterization information based on digital twins received from the components. The computed configuration and parameterization information is transmitted to the components (e.g., to controllers associated with the components) to enable the components to implement the configuration and parameterization information to control the components. These aspects of the disclosure constitute technical features that yield the technical effect of improving power systems and energy control systems by enabling centralized and decentralized control of components in the power system based on digital twins for each component. As a result of these technical features and technical effects, an energy control system in accordance with example embodiments of the disclosure represents an improvement to existing power system control techniques. It should be appreciated that the above examples of technical features, technical effects, and improvements to technology of example embodiments of the disclosure are merely illustrative and not exhaustive. These and other benefits will be apparent as described herein.

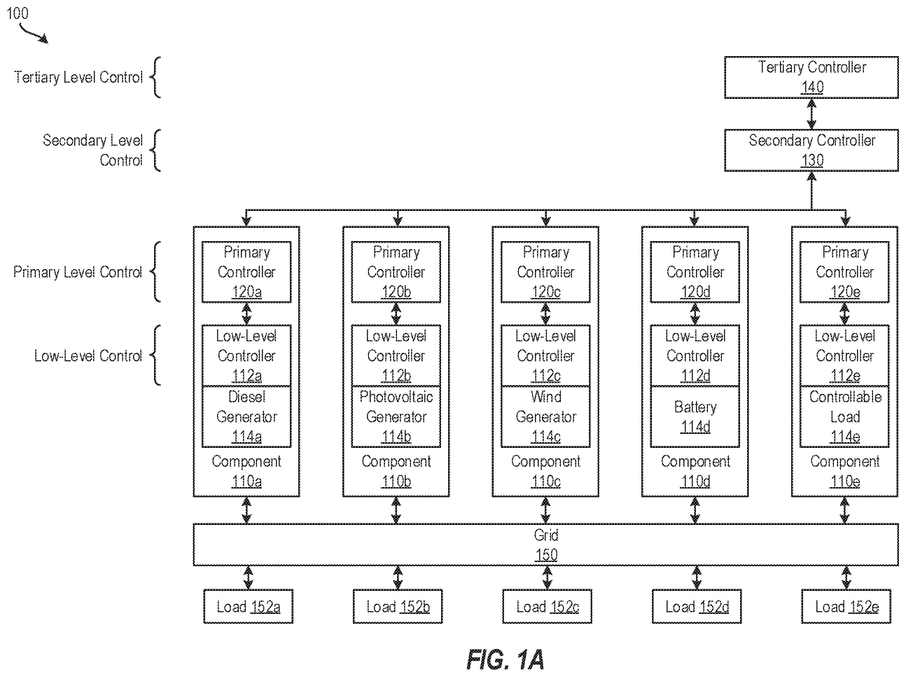

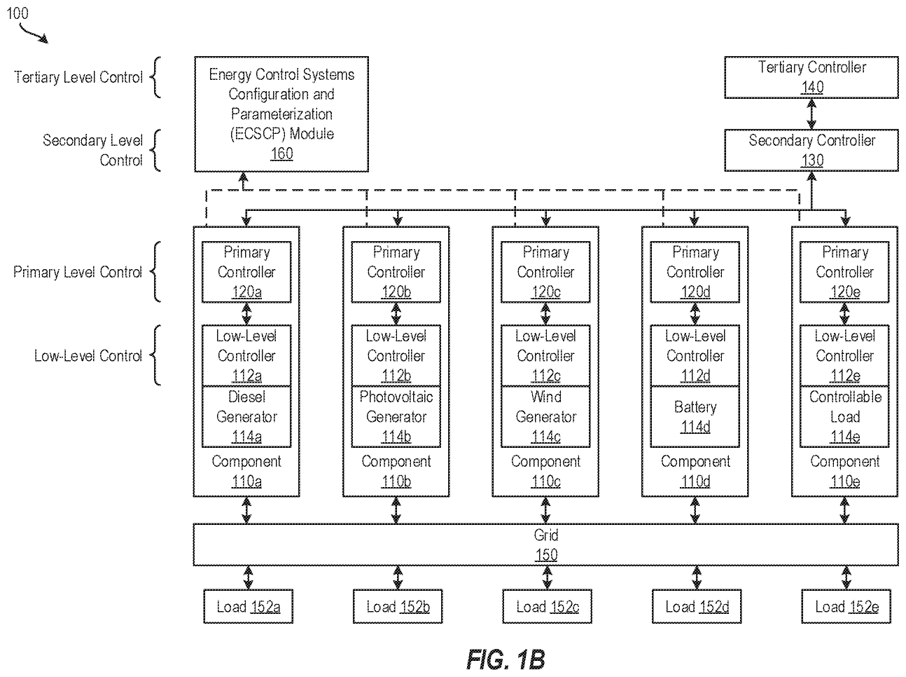

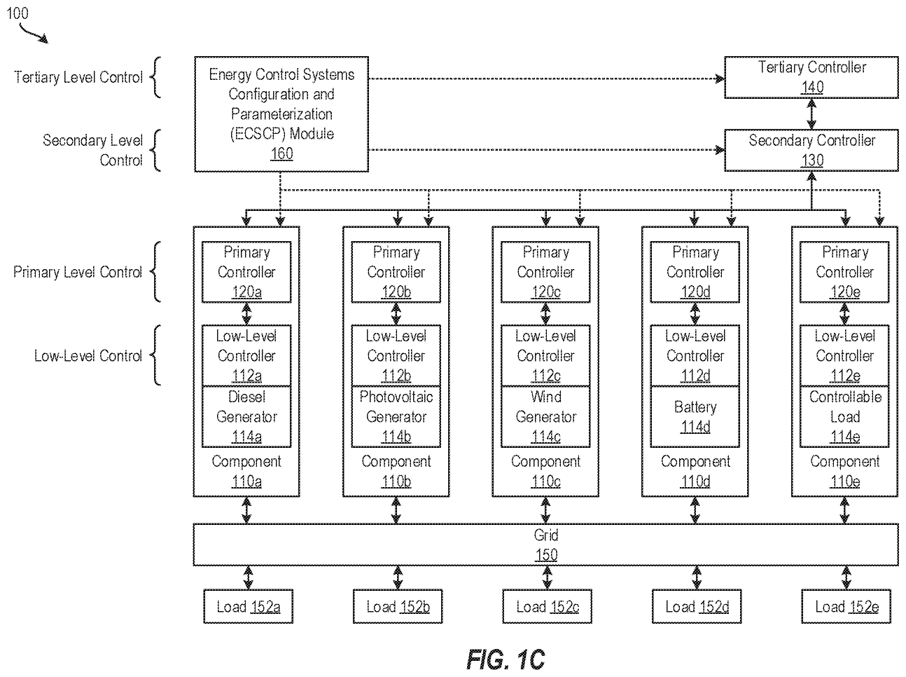

FIG. 1A depicts a block diagram of an energy control system 100, according to aspects of the present disclosure. Although FIG. 1A depicts a purely electrical energy system, the present techniques can also be applied to multi-modal energy systems (i.e., energy systems that comprise electrical, thermal, chemical, and/or mechanical energy and their conversions).

The energy control system 100 enables the control of components 110a, 110b, 110c, 110d, 110e (collectively “components 110”) of a power system (e.g., a grid 150 and various loads 152a, 152b, 152c, 152d, 152e (collectively “loads 152”)). The components 110 produce electrical power and transmit the electrical power over the grid 150 to end users (represented by the loads 152).

The components 110 include electrical hardware such as a diesel generator 114a, a photovoltaic generator 114b, a wind generator 114c, battery storage 114d, a controllable load 114e (collectively “generation hardware 114”). Other types of generation hardware 114 can be implemented, such as gas turbines, coal power plants, nuclear power plants, hydroelectric power plants, etc.

According to aspects of the present disclosure, the energy control system 100 includes four control levels: low-level control, primary level control, secondary level control, and tertiary level control. In particular, the generation hardware 114 can be controlled from various controllers, including: low-level controllers 112a, 112b, 112c, 112d, 112e (collectively “low-level controller 112”); primary controllers 120a, 120b, 120c, 120d, 120e (collectively “primary controller 120”); a secondary controller 130, and a tertiary controller 140. While FIG. 1A depicts centralized secondary and tertiary control levels as well as decentralized primary and low-level control levels, other configurations are also possible (e.g., control levels can be combined, a control level can be divided into multiple control levels, etc.). Accordingly, the exemplary embodiments shown in the accompanying drawings aid in the understanding of the present disclosure but are not limiting as other configurations with additional, fewer, or alternative components can be contemplated within the scope of this disclosure. The individual control levels are briefly described as follows.

The low-level controllers 112 provide decentralized, local control to the respective individual generation hardware 114 such that the output voltage of the generation hardware 114 satisfies certain conditions (e.g. 110V at 60 Hz, etc.). For example, the low-level controller 112a controls the diesel generator 114a, the low-level controller 112b controls the photovoltaic generator 114b, and so on. Since this requires very fast reaction (e.g., in the millisecond range to changes in the grid 150, short circuits, etc.), this control level is usually located within controller hardware of each component 110.

The primary controllers 120 also provide decentralized, local control to the components 110 and are used to achieve a fast power balancing between the individual components 110. In classical alternating current (AC) grids, this can be achieved through frequency-active power droop controllers (f-P-droop controllers) and voltage-reactive power droop controllers (Q-U-droop controllers). In direct current (DC) grids, this can be achieved through voltage-active power droop controllers (U-P-droop controllers). Primary controllers 120 typically run with a sampling rate between 100 ms and 1 s and provide voltage and/or power set-points to the low-level controllers 112. Like the low-level controllers 112, the primary controllers 120 are usually implemented within controller hardware of each component 110.

The secondary controller 130 is a centralized controller in the sense that it controls multiple components 110. The secondary controller 130 coordinates the individual primary controllers 120 for each component 110. For example, the secondary controller 130 can be an integral controller to achieve zero steady-state frequency offset for grid 150 stability. The secondary controller 130 provides set-points to the primary controllers 120 with a sampling rate of multiple seconds to minutes, for example. Different centralized and decentralized secondary controllers can also be implemented.

The tertiary controller 140 provides another form of centralized control. For example, the tertiary controller 140 can be used for the economically optimal dispatch of the generators at sampling rates of, for example, 15 minutes. Like the secondary controller 130, different centralized and decentralized approaches for tertiary control can be implemented. For example, in practical island grids, the tertiary controller 140 can be implemented in a centralized energy management system. In large energy systems, the tertiary controller is replaced, for example, by an energy market.

Existing energy control systems are configured and parameterized manually during engineering and commissioning. The low-level controllers 112 are configured and parametrized manually. In simpler applications, they are configured and parametrized during commissioning based in standard test cases that are executed on the real plant. In more complex cases, the low-level controllers 112 are configured and parametrized in simulations studies. More complex cases include for examples power systems with a high share of renewable generation and/or power electronic converters. In each case, this manual configuration and parametrization is expensive and time-consuming. Analysis has shown that this approach will not be feasible in future power systems that incorporate high renewable-based power generation in large-scale networks because of the fluctuating dynamics of the power system depending, for example, on the weather.

Primary controllers 120 are usually configured and parametrized during commissioning based on rules of thumb and/or experience. As long as the power system is small this is sufficient but becomes unmanageable for larger power systems. Secondary control is again parameterized during commissioning. Relevant parameters can include, for example, gain and sampling rate of the integral controller to reduce frequency offsets.

Tertiary level controller for islanded power systems can be based on model-predictive controllers (MPC). MPC combines cost functions of the individual components 110 as well as local and global constraints of the power system (e.g., battery state-of-charge or N-1 stability constraints). The resulting optimization problem is solved on a receding horizon to achieve cost-minimal power generation. However, the MPC requires manual configuration and parameterization based on cost functions and constraints from the individual components as well as overall constraints. Because this approach is largely manual, it is therefore costly and time-consuming. Moreover, this approach is inflexible and cannot easily adapt, for example, if a new component (or a new type of component) is introduced or if a component is removed.

FIGS. 1B and 1C depict a block diagram of the energy control system 100 of FIG. 1A having an energy control systems configuration and parameterization (ECSCP) module 160, according to aspects of the present disclosure. In particular, FIG. 1B depicts digital twins being transmitted by the components 110 to the ECSCP module 160 (dashed lines) while FIG. 1C depicts parameters being transmitted by the ECSCP module 160 to the components 110, the secondary controller 130, and the tertiary controller 140 (dotted lines).

The various controllers and modules (e.g., the ECSCP module 160, the low-level controller 112, the primary controller 120, the secondary controller 130, and/or the tertiary controller 140) described regarding FIGS. 1A-1C can be implemented as instructions stored on a computer-readable storage medium, as hardware modules, as special-purpose hardware (e.g., application specific hardware, application specific integrated circuits (ASICs), as embedded controllers, hardwired circuitry, etc.), or as some combination or combinations of these. In examples, the engine(s) described herein can be a combination of hardware and programming. The programming can be processor executable instructions stored on a tangible memory, and the hardware can include a processing device for executing those instructions. Thus a system memory can store program instructions that when executed by the processing device implement the controllers and modules described herein. Other controllers and/or modules can also be utilized to include other features and functionality described in other examples herein.

Alternatively or additionally, the energy control system 100 can include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein.

With reference to FIG. 1B, each of the components 110 contains a digital twin (i.e., a digital representation of the component). Examples of data contained in the digital twin can include the following: block diagrams representing the component's control structures and tunable parameters (e.g., based on IEEE reference models for power converters, diesel generators, gas turbines, etc.); a cost function for power generation; component-specific constraints (e.g., capacity of a battery (e.g., battery 114d)); typical profiles for loads (e.g., loads 152); and/or state-of-health of the component.

The components that contain a digital twin send their respective digital twins using a communication network (represented by the dashed lines) to the ECSCP module 160. The ECSCP module 160 is part of a centralized energy management system that also contains secondary and tertiary control functionality (i.e., the secondary controller 130 of the secondary level control and the tertiary controller 140 of the tertiary level control). In some examples, if the secondary and tertiary control is distributed (e.g., in an energy market), the ESCPS module could also be distributed.

The ECSCP module 160 collects the digital twins from the components 110 and combines them in order to compute configuration and parameterization information for the complete energy control system. For example, the ECSCP module 160 uses cost functions of the components 110 and/or specific constraints of the components 110 to configure and parameterize the MPC problem for the tertiary controller 140. Moreover, the ECSCP module 160 can take advantage of other techniques to parameterize the primary controllers 120 and/or the low-level controllers 112.

According to examples of the present disclosure, the ECSCP module 160 can compute configuration and parameterization information to enable power oscillation damping and/or energy management. Power oscillation damping occurs when a component (e.g., a generator, a power line, a transformer, etc.) is dropped from the power system. In such cases, to compute configuration and parameterization information, the ECSCP module 160 can derive a dynamic model of the power system by interconnecting the dynamic models of each component (obtained as digital twins from each component) through the power flow equation (e.g., implemented during commissioning), derive an equivalent model for the dropout component, linearize the equivalent model, satisfy power system constraints when the dropout occurs, and determine optimal parameters of a controller(s) to achieve an optimization goal.

Energy management can be achieved by suitably configuring and parameterizing the tertiary controller 140. In this case, each component 110 provides a cost function as digital twin that describes how much power it can supply to the grid 150 at what cost. For example, for a diesel generator, the cost function depends on the fuel cost. In addition, the components 110 can have constraints that are also added to the digital twin, like the capacity of the battery or the capacity of the fuel tanks of a diesel generator. Combining these digital twins, the ECSCP 160 configures and parameterizes the tertiary controller 140 with the sum of all cost functions as an overall cost function and the constraints of all generators as constraints.

After the computation of the configuration and parameterization, the ECSCP module 160 can execute simulations tests to verify whether pre-specified constraints are satisfied. In general, the configuration and parameterization information is computed using a simplified or reduced version of the combined digital twin (e.g. the combined digital twin is a nonlinear differential equation and the configuration and parameterization is computed using a linearized version of it). In order to verify the configuration and parameterization, this configuration and parameterization information is applied to the original nonlinear differential equation digital twin. Subsequently, simulations of this nonlinear differential equation combined digital twin are executed for a set of typical test cases (e.g. load changes, loss of a generation unit, and/or loss of a power line, etc.). In some examples, a fast simulation of the differential algebraic systems during operation can be implemented. The simulation results are then used to verify that the configuration and parameterization information does achieve the required performance.

Once the configuration and parameter information is computed, the ECSCP module 160 sends the configuration and parameter information to the individual controllers (e.g., the primary controllers 120 and/or the low-level controllers 112) of the components, as shown by the dotted lines in FIG. 1C. The configuration and parameter information can also be sent to the secondary controller 130 to implement a scheme for coordination of voltage and frequency (U/f) control for power grid stability and/or to the tertiary controller 140 to implement a cost-optimal power scheduling scheme to reduce costs (e.g., using components 110 at optimal times to experience cost savings).

During commissioning, additional data that is not readily available can be obtained using additional calibration tests (e.g., in the case of a diesel generator, measure the dynamic behavior of a diesel generator after a series of load steps in order to determine/identify (parts of) its digital twin based on these measurements; or, in the case of battery systems, apply specific voltage and/or current profiles to the power system in order to identify a transformer that connects the output of the battery system to the medium voltage grid). This is particularly helpful for components 110 that do not have a digital twin (e.g., transformers or uncontrolled loads). In such cases, a digital twin can be generated during commissioning. The ECSCP module 160 can also contain a user interface that guides an operator (e.g., a commissioning engineer) through the calibration tests, for example.

According to aspects of the present disclosure, the ECSCP module 160 can contain an additional verification module to verify digital twins. For example, the ECSCP module 160 can automatically execute or suggest specific test sequences during commissioning to be executed with the individual components 110. The ECSCP module 160 can also contain a parameter identification module that identifies and/or corrects missing and/or wrong parameters of the digital twins based on measurements taken during digital twin verification. In another example, the ECSCP module 160 can execute these verification tests online (i.e., during operation). This can be accomplished, for example, based on phase-measurement units (PMU) in transmission systems.

In some examples, a highly resilient energy system may be desired. In such cases, the ECSCP module 160 can be implemented in several, independent hardware units (e.g., in a distributed system). This prevents a single point of failure. In this case, one hardware unit is actively executing the ECSCP module 160 while another hardware unit(s) is in standby. These standby hardware units synchronize their internal representations (i.e., the combination of the digital twins) with the active hardware unit. If the active unit experiences a failure (e.g., the hardware unit crashes, the hardware unit becomes offline, etc.), the next hardware unit takes over without interruption. In another example, this could even be implemented completely distributed on all components 110. For example, every component controller (e.g., low-level controllers 112, primary controllers 120) contains an ECSCP module. One component (e.g., the component 110a) is selected to host the active ECSCP module instance. If this component (e.g., the component 110a) fails, the next component (e.g., the component 110b) takes over as the active ECSCP. This approach can be useful in tactical military microgrids or in areas that suffer from regular natural catastrophes (e.g., earthquakes, hurricanes, tornados, etc.). In the latter case, the power system can be build up based on the components that are still operational. Accordingly, a highly resilient energy control system is provided. Assuming that some of the hardware is still operational after a natural catastrophe, the present techniques enable the energy control system to re-configure and re-parameterize itself and return to operation quickly and/or without manual intervention.

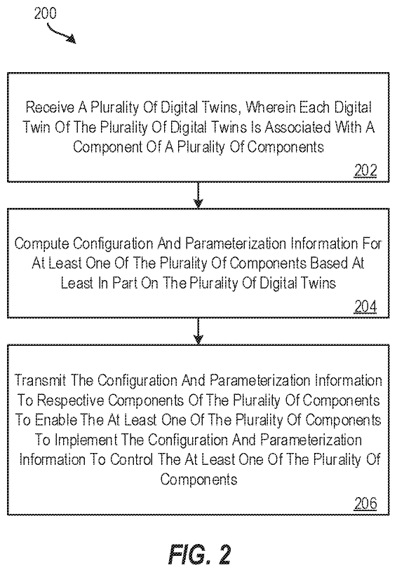

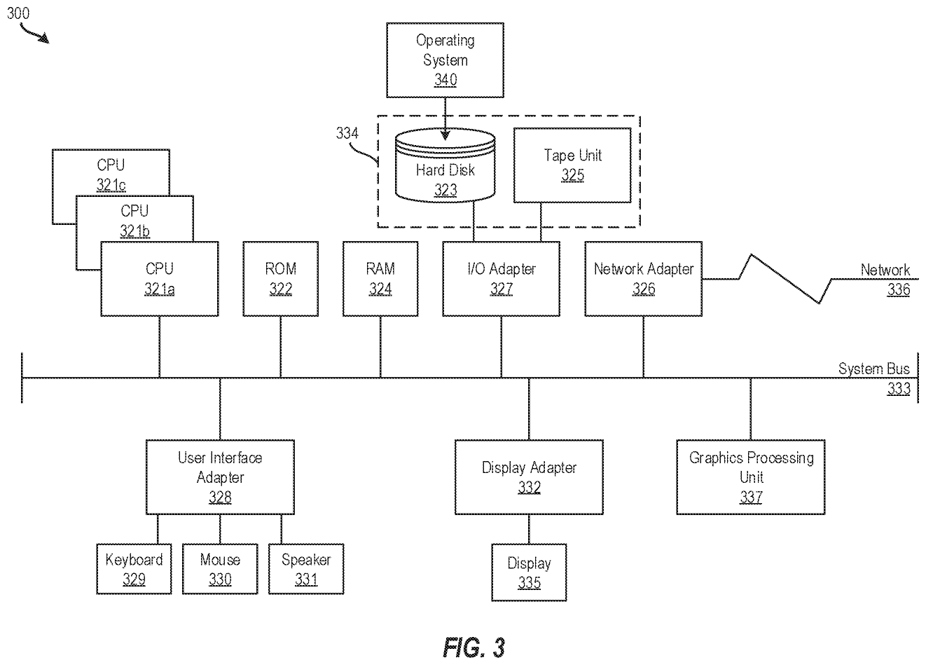

FIG. 2 depicts a flow diagram of a method 200 for configuring and parameterizing an energy control system, according to aspects of the present disclosure. The method can be performed by suitable processing systems, such as the energy control system 100, the processing system 300 of FIG. 3, suitable combinations thereof, and/or another suitable processing system.

At block 202, the ECSCP module 160 (or a suitable processing device) receives a plurality of digital twins, wherein each digital twin of the plurality of digital twins is associated with a component of a plurality of components (e.g., the components 110). In an example, one or more of the digital twins can be verified using, for example, simulations tests to verify whether pre-specified constraints are specified.

At block 204, the ECSCP module 160 (or a suitable processing device) computes configuration and parameterization information for at least one of the plurality of components based at least in part on the plurality of digital twins. In an example, prior to computing the configuration and parameterization information, the plurality of digital twins can be combined and computing the configuration and parameterization information can then be based at least in part on the combined plurality of digital twins. For example, the ECSCP module 160 combines cost functions for the components 110. In another example, the ECSCP module 160 (or a suitable processing device) computes configuration and parameterization information for at least one of a secondary controller 130 and a tertiary controller 140 based at least in part on the plurality of digital twins.

At block 206, the ECSCP module 160 (or a suitable processing device) transmits the configuration and parameterization information to respective components of the plurality of components to enable the at least one of the plurality of components to implement the configuration and parameterization information to control the at least one of the plurality of components. This enables the components 110 to be configured and parameterized for use. In some examples, only the secondary controller 130 and tertiary controller 140 are configured but not the low-level controller 112 and the primary controller 120. In another example, the ECSCP module 160 (or a suitable processing device) transmits the configuration and parameterization information to the at least one of the secondary controller 130 and the tertiary controller 140 to enable the at least one of the secondary controller 130 and the tertiary controller 140 to implement the configuration and parameterization information.

Additional processes also can be included. For example, the ECSCP module 160 (or a suitable processing device) transmits the configuration and parametrization information to the secondary controller 130 to enable the secondary controller 130 to implement a voltage and frequency control scheme based at least in part on the configuration and parametrization information.

In another example, the ECSCP module 160 (or a suitable processing device) transmits the configuration and parametrization information to the tertiary controller 140 to enable the tertiary controller 140 implement a power scheduling scheme based at least in part on the configuration and parametrization information. For example, the tertiary controller 140 can implement cost-optimal power scheduling.

In yet another example, a calibration test can be performed on a component to generate a digital twin for that component. This can be useful if a particular component does not contain a digital twin. It should be understood that the processes depicted in FIG. 2 represent illustrations, and that other processes can be added or existing processes can be removed, modified, or rearranged without departing from the scope and spirit of the present disclosure.

The method 200 can be executed repeatedly online in parallel to the operation described in FIG. 1A. Accordingly, the method 200 can adapt and optimize the energy control system during operation. This adaptation can be useful if some components 110 are not operational (e.g., undergoing maintenance, decommissioned, or faulty) or if new components are added to the system.

It is understood that the present techniques are capable of being implemented in conjunction with any other suitable type of computing environment now known or later developed. For example, FIG. 3 illustrates a block diagram of a processing system 300 for implementing the techniques described herein. In examples, processing system 300 has one or more central processing units (i.e., processors, processing devices) 321a, 321b, 321c, etc. (collectively or generically referred to as processor(s) 321 and/or as processing device(s)). In aspects of the present disclosure, each processor 321 can include a reduced instruction set computer (RISC) microprocessor. Processors 321 are coupled to system memory (e.g., random access memory (RAM) 324) and various other components via a system bus 333. Read only memory (ROM) 322 is coupled to system bus 333 and can include a basic input/output system (BIOS), which controls certain basic functions of processing system 300.

Further illustrated are an input/output (I/O) adapter 327 and a network adapter 326 coupled to system bus 333. I/O adapter 327 can be a small computer system interface (SCSI) adapter that communicates with a hard disk 323 and/or a tape storage drive 325 or any other similar component. I/O adapter 327, hard disk 323, and tape storage device 325 are collectively referred to herein as mass storage 334. Operating system 340 for execution on processing system 300 can be stored in mass storage 334. A network adapter 326 interconnects system bus 333 with an outside network 336 enabling processing system 300 to communicate with other such systems.

A display (e.g., a display monitor) 335 is connected to system bus 333 by display adaptor 332, which can include a graphics adapter to improve the performance of graphics intensive applications and a video controller. In one aspect of the present disclosure, adapters 326, 327, and/or 332 can be connected to one or more I/O busses that are connected to system bus 333 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 333 via user interface adapter 328 and display adapter 332. A keyboard 329, mouse 330, and speaker 331 can be interconnected to system bus 333 via user interface adapter 328, which can include, for example, a Super I/O chip integrating multiple device adapters into a single integrated circuit.

In some aspects of the present disclosure, processing system 300 includes a graphics processing unit 337. Graphics processing unit 337 is a specialized electronic circuit designed to manipulate and alter memory to accelerate the creation of images in a frame buffer intended for output to a display. In general, graphics processing unit 337 is very efficient at manipulating computer graphics and image processing, and has a highly parallel structure that makes it more effective than general-purpose CPUs for algorithms where processing of large blocks of data is done in parallel.

Thus, as configured herein, processing system 300 includes processing capability in the form of processors 321, storage capability including system memory (e.g., RAM 324), and mass storage 334, input means such as keyboard 329 and mouse 330, and output capability including speaker 331 and display 335. In some aspects of the present disclosure, a portion of system memory (e.g., RAM 324) and mass storage 334 collectively store an operating system such as the AIX® operating system from IBM Corporation to coordinate the functions of the various components shown in processing system 300.

The descriptions of the various examples of the present disclosure have been presented for purposes of illustration, but are not intended to be exhaustive or limited to the embodiments disclosed. Many modifications and variations will be apparent to those of ordinary skill in the art without departing from the scope and spirit of the described techniques. The terminology used herein was chosen to best explain the principles of the present techniques, the practical application or technical improvement over technologies found in the marketplace, or to enable others of ordinary skill in the art to understand the techniques disclosed herein.

What is claimed is:

1. A computer-implemented method for configuring and parameterizing an energy control system, the method comprising:
performing, by a processing device, a calibration test on at least one of a plurality of components to generate a digital twin for that component;
receiving, by a the processing device, a plurality of digital twins, wherein each digital twin of the plurality of digital twins is associated with a component of a the plurality of components;
computing, by the processing device, configuration and parameterization information for at least one of the plurality of components based at least in part on the plurality of digital twins; and
transmitting, by the processing device, the configuration and parameterization information to respective components of the plurality of components to enable the at least one of the plurality of components to implement the configuration and parameterization information to control the at least one of the plurality of components.

2. The computer-implemented method of claim 1, further comprising:
transmitting, by the processing device, the configuration and parametrization information to a secondary controller to enable the secondary controller to implement a voltage and frequency control scheme based at least in part on the configuration and parametrization information.

3. The computer-implemented method of claim 1, further comprising:
transmitting, by the processing device, the configuration and parametrization information to a tertiary controller to enable the tertiary controller to implement a power scheduling scheme based at least in part on the configuration and parametrization information.

4. The computer-implemented method of claim 3, wherein the power scheduling scheme is a cost-optimal power scheduling scheme.

5. (canceled)

6. The computer-implemented method of claim 1, further comprising:
subsequent to receiving the plurality of digital twins, verifying, by the processing device, at least one of the plurality of digital twins.

7. The computer-implemented method of claim 1, further comprising:
prior to computing the configuration and parameterization information, combining, by the processing device, the plurality of digital twins, wherein computing the configuration and parameterization information is based at least in part on the combined plurality of digital twins.

8. The computer-implemented method of claim 1, wherein each of the digital twins comprises data about the component with which each digital twin is associated.

9. The computer-implemented method of claim 8, wherein the data comprises one or more of the following: a block diagram representing a structure and a tunable parameter of the component; a cost function for power generation; component specific constraints; a typical load profile for loads; and a state-of-health of the component.

10. A system for configuring and parameterizing an energy control system, the system comprising:
a plurality of components;
a memory comprising computer readable instructions; and
a processing device for executing the computer readable instructions for performing a method, the method comprising:
performing, by the processing device, a calibration test of at least one of a plurality of components to generate a digital twin of that component;
receiving, by the processing device, a plurality of digital twins, wherein each digital twin of the plurality of digital twins is associated with a component of a the plurality of components;
computing, by the processing device, configuration and parameterization information for at least one of the plurality of components based at least in part on the plurality of digital twins; and
transmitting, by the processing device, the configuration and parameterization information to respective components of the plurality of components to enable the at least one of the plurality of components to implement the configuration and parameterization information to control the at least one of the plurality of components.

11. The system of claim 10, wherein the method further comprises:
transmitting, by the processing device, the configuration and parametrization information to a secondary controller to enable the secondary controller to implement a voltage and frequency control scheme based at least in part on the configuration and parametrization information.

12. The system of claim 10, wherein the method further comprises:
transmitting, by the processing device, the configuration and parametrization information to a tertiary controller to enable the tertiary controller to implement a power scheduling scheme based at least in part on the configuration and parametrization information.

13. The system of claim 12, wherein the power scheduling scheme is a cost-optimal power scheduling scheme.

14. (canceled)

15. The system of claim 10, wherein the method further comprises:
subsequent to receiving the plurality of digital twins, verifying, by the processing device, at least one of the plurality of digital twins.

16. The system of claim 10, wherein the method further comprises:
prior to computing the configuration and parameterization information, combining, by the processing device, the plurality of digital twins, wherein computing the configuration and parameterization information is based at least in part on the combined plurality of digital twins.

17. The system of claim 10, wherein each of the digital twins comprises data about the component with which each digital twin is associated, and wherein the data comprises one or more of the following: a block diagram representing a structure and a tunable parameter of the component; a cost function for power generation; component specific constraints; a typical load profile for loads; and a state-of-health of the component.

18. A method for configuring and parameterizing an energy control system, the method comprising:
receiving, by a processing device, a plurality of digital twins, wherein each digital twin of the plurality of digital twins is associated with a component of a plurality of components;
computing, by the processing device, configuration and parameterization information for at least one of a secondary controller and a tertiary controller based at least in part on the plurality of digital twins; and
transmitting, by the processing device, the configuration and parameterization information to the at least one of the secondary controller and the tertiary controller to enable the at least one of the secondary controller and the tertiary controller to implement the configuration and parameterization information.

19. The method of claim 18, wherein transmitting further comprises transmitting the configuration and parametrization information to the secondary controller to enable the secondary controller to implement a voltage and frequency control scheme based at least in part on the configuration and parametrization information.

20. The method of claim 18, wherein transmitting further comprises transmitting the configuration and parametrization information to the tertiary controller to enable the tertiary controller to implement a power scheduling scheme based at least in part on the configuration and parametrization information, wherein the power scheduling scheme is a cost-optimal power scheduling scheme.
